(19) United States
(12) Patent Application Publication
(10) Pub. No.: US 2006/0289520 A1
(43) Pub. Date: Dec. 28, 2006

(54) Package for storage and dispensing of small items

(76) Inventor: Clay Brooke, Plymouth (GB)

Correspondence Address: Douglas J. Hura, Esquire;DENTSPLY International Inc., 570 West College Avenue, P.O. Box 872, York, PA, 17405-0872, US

(21) Appl. No.: 11/351,039

(22) Filed: Feb. 8, 2006

Related U.S. Application Data
(60) Provisional application No. 60/651,031, filed on Feb. 8, 2005.

(51) Int. Cl. H05B 6/80

(52) U.S. Cl. 219/730

(57) ABSTRACT

A package (10) for an item (70) includes a closeable cover (21). The cover (21) is provided with at least one aperture (60). A pierceable layer (71) is provided to cover or otherwise close the aperture (60) and a deformable layer (80) is provided to at least partially enclose the aperture (60) such that the item (70) is held between the deformable layer (80) and the pierceable layer (71). In use, to remove the item (70), the deformable layer (80) is deformed such that pressure is exerted upon the item (70) of sufficient force that the item (70) causes the pierceable layer (71) to be pierced, destroyed, broken or otherwise removed such that the item (70) can then be removed for use.

### RELATED APPLICATIONS

This application claims the benefit of U.S. Provisional Application Ser. No. 60/651,031 filed on Feb. 8, 2005 (ASH-020403).

### TECHNICAL FIELD

The present invention is directed toward a package for small items such as drill bits, dental burs, pins, nuts, bolts or any such items where it is desirable to provide one or more of such items in a sealed even sterile manner. The package also facilitates the dispensing of the items.

### BACKGROUND OF THE INVENTION

In certain industrial, medical and dental fields it is often desired to provide to an end user at least one and sometimes a plurality of items that are relatively small. That is, which items are generally manipulated by hand. It is also sometimes desirable that the items be sealed prior to use and in fact, it is sometimes desirable to keep the items in a sterile environment prior to use.

In the case of delicate instruments, such as drill bits, dental burs and the like, it is often also necessary to protect fine cutting edges, screw threads and the like prior to use. Therefore, hard plastic cases are often used to store the items prior to use. While such plastic cases work well for this purpose, they are expensive to manufacture especially when sterility is required.

A need exists therefore, for a less expensive means of packaging such items when it is desired for whatever reason to segregate one or more items prior to use. The package should be simple to manipulate to remove the item or items and should provide a direct indication of the item contained therein and whether or not a particular item has been removed.

### SUMMARY OF THE INVENTION

It is therefore, an object of the present invention to provide a package for one or more small items.

It is another object of the invention to provide such a package that is relatively inexpensive to fabricate.

It is another object of the invention to provide such a package that is simple to manipulate.

It is still another object of the invention to provide such a package that will maintain the item or items therein in a sealed manner.

These and other objects of the invention, which shall become apparent in the present specification are carried out by the invention as hereinafter described and claimed.

In general a package for an item includes a closeable cover and means to maintain the cover in its closed manner. The cover is provided with at least one aperture that is preferably larger than the item. A pierceable layer is provided to cover the aperture and a deformable layer is provided to at least partially enclose the aperture such that the item is held between the deformable layer and the pierceable layer. In use, to remove the item, the deformable layer is deformed such that pressure is exerted upon the item of sufficient force that the item causes the pierceable layer to be pierced, destroyed or otherwise broken through such that the item can then be removed for use.

### BRIEF DESCRIPTION OF THE DRAWINGS

FIG. 1 is a perspective view of a plurality of packages according to the present invention, stored together in a box and which for environmental purposes is shown as containing a plurality of dental burs.

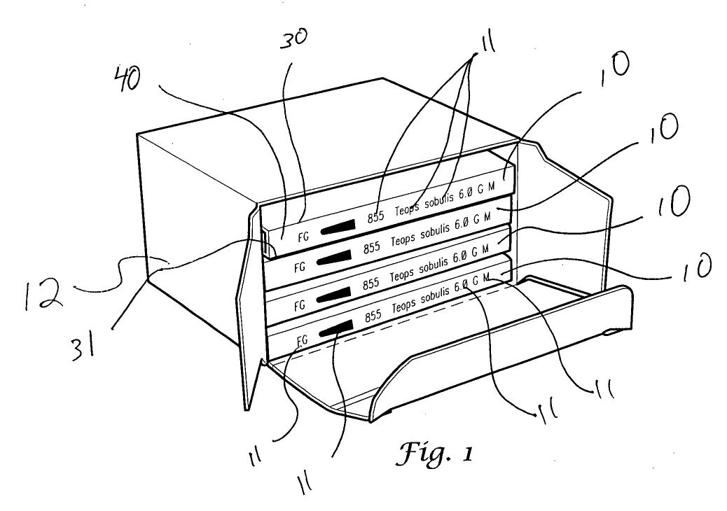

FIG. 2 shows an example of a user removing one of the inventive packages from the box shown in FIG. 1.

FIG. 3 shows a user preparing to remove an item from the package of FIG. 2.

FIG. 4 shows a sequential step in the operation of removing an item from the package shown in FIG. 3.

FIG. 5 shows a sequential step in the operation of removing an item from the package shown in FIG. 4.

FIG. 6 shows a sequential step in the operation of removing an item from the package shown in FIG. 5.

FIG. 7 shows a sequential step in the operation of removing an item from the package shown in FIG. 6.

FIG. 8 shows two different embodiments of one package as in FIG. 1.

FIG. 9 shows an alternate view of the packages of FIG. 8.

FIG. 10 shows an exploded view of one of the packages of FIG. 9.

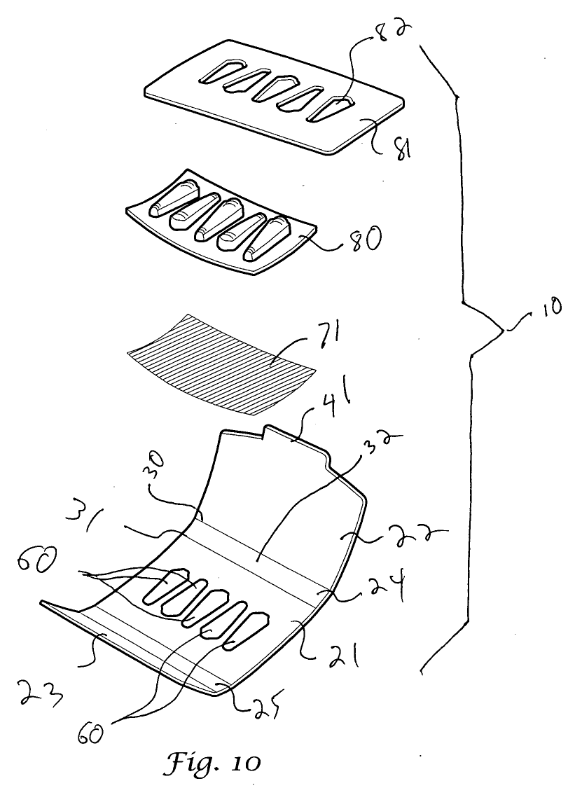

### PREFERRED EMBODIMENTS FOR CARRYING OUT THE INVENTION

An example of a package according to the present invention is generally designated on the drawings by the number 10. Package 10 can be employed to contain any number of items of any size or shape. The invention is particularly suited for relatively small items that are routinely manipulated by hand. Such items are not a limitation of the invention but include by way of example, drill bits, dental burs, pins, nuts, bolts or any such items. The invention will be exemplified herein with dental burs. It is desirable to segregate dental burs prior to use to maintain their operating surfaces in the required physical condition, and it is often desirable to maintain them in a clean or even sterile environment prior to use.

Each package 10 may be provided with indicia 11 that shows data concerning the items are contained therein. One or more packages 10 may be provided or grouped together such as in a box 12.

Package 10 for an item 20 (depicted as being a dental bur for environmental purposes only) includes a closeable cover 21. Cover 21 is provided with at least one and preferably two flaps 22 and 23 hingedly connected to cover 21. Preferably, the hinged connection is a living hinge 24 and 25 respectively. Living hinge 24 is preferably provided with a first living hinge part 30 and a second living hinge part 31, such that there is an expanse 32 therebetween. In this manner, when cover 21 is closed expanse 32 forms a sidewall 40 such as may be used to display indicia 11.

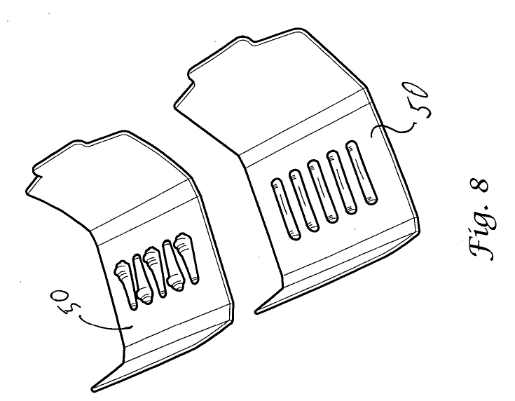

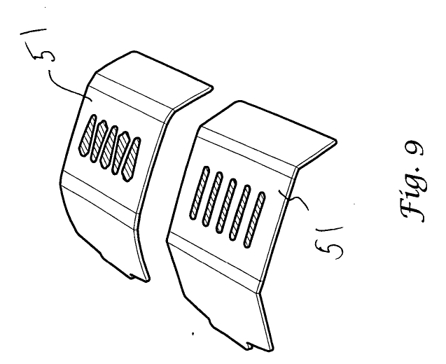

Preferably cover 10 has some means to hold flaps 22 and 23 in their closed position such as a tab 41 that can be placed under flap 23. Any means of closure is within the scope of the present invention includes the use of fasteners, slots, tabs, pressure sensitive adhesives or the like. When closed, cover 21 has an inside area 50 (FIG. 8) and an outside area 51 (FIG. 9).

Cover 21 is preferably provided with at least one and even a plurality of through apertures 60. Apertures 60 are preferably sized and shaped to allow an item such as dental bur 70 to pass therethrough. It is not shown in the drawings but is within the scope of the invention to provide an aperture 60 that is not larger than item 70 but it is preferred that the aperture be at least somewhat larger than item 70.

A pierceable layer 71 is provided in an opposed and physically contacting manner to cover 21 such that pierceable layer 71 closes aperture 60. By being pierceable it is understood that with sufficient force, layer 71 is pierced, broken, destroyed or otherwise opened in a destructive or non-destructive manner to allow item 70 to be removed through aperture 60. A metal foil layer is useful for destructive removal although a suitable paper or polymeric material could also be used. A releasable layer (not shown) could be used for non-destructive removal.

A deformable layer 80 is preferably provided to cover at least one aperture 60 and pierceable layer 71. By deformable, it is meant that a user can press with a finger or tool to deform at least a portion of deformable layer 80 in a direction toward aperture 60. Preferably deformable layer 80 is a polymeric material that is shaped such as by vacuum forming or the like to have a profile at least somewhat approximating item 70. When placed over aperture 60 with item 70 between deformable layer 80 and pierceable layer 71, item 70 is held therein in the manner of a blister pack. In use the user will press upon an individual blister such as 80a to force it toward aperture 60. It may be useful to provide a positioning layer 81 having corresponding apertures 82 over deformable layer 80.

It will be understood that each of the individual components including pierceable layer 71, deformable layer 80 and positioning layer 81 if employed are affixed to cover 21 and or each other by any means such as an adhesive.

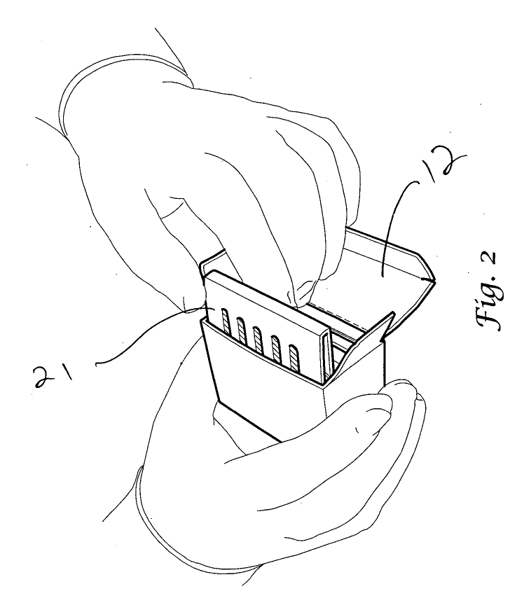

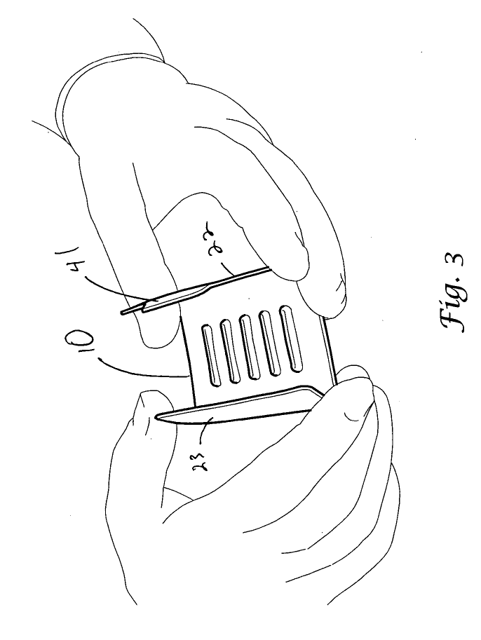

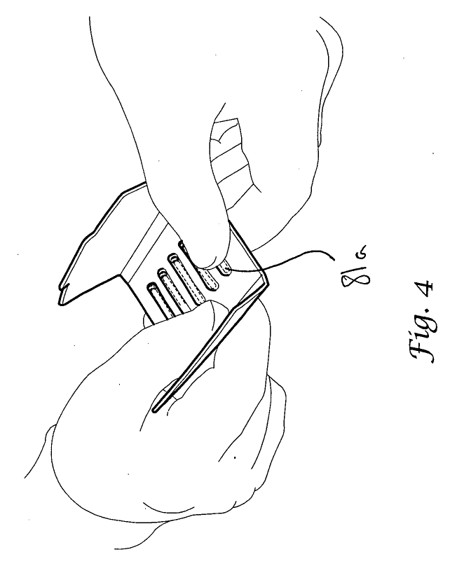

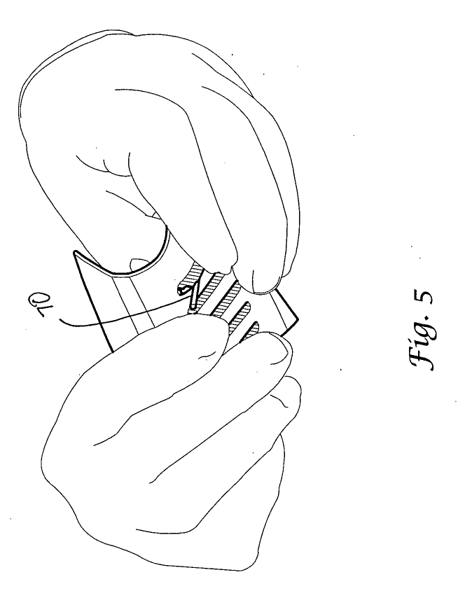

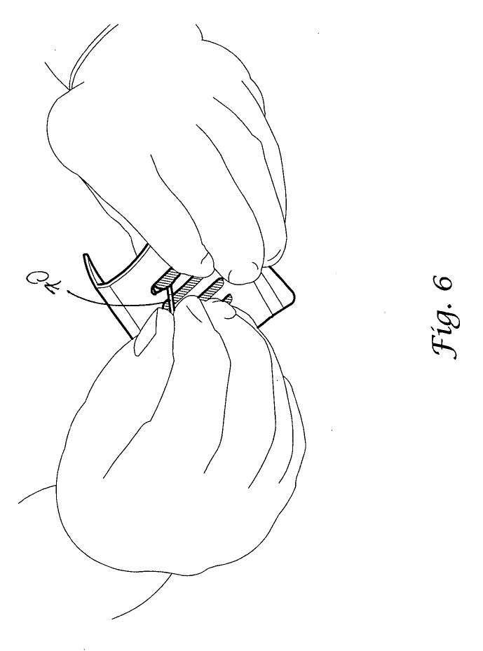

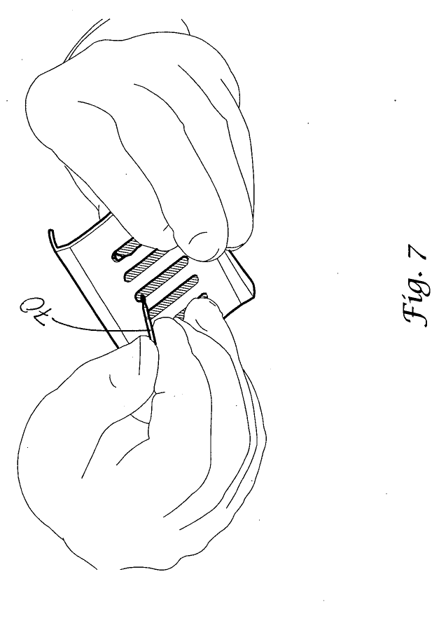

FIGS. 2-7 sequentially depict a user removing an item 70 from a package 10. FIG. 2 shows the user removing an individual package 10 from a plurality of packages 10 held within a box 12. FIG. 3 shows the user opening the package 10 by pulling on flaps 22 and 23 thus moving living hinges 24 and 25. Tab 41 has thus been disengaged from flap 23. In FIG. 4, the user is pressing upon a blister 81 a such that blister 81 a is deformed to such a degree that as shown in FIG. 5, item 70 is caused to pierced pierceable layer 71. The user may then grasp item 70 as shown in FIG. 6 and remove item 70 from package 10 as shown in FIG. 7.

It is now apparent that the invention as described herein carries out the objectives of the invention. The present invention has been described herein and shown on the drawings without showing all of the alternative embodiments that are evident and that are within the scope thereof. The scope of the invention shall be determined only by any associated claims.

What is claimed is:

1. A package for a dental item comprising a closeable cover and means to maintain the cover in its closed manner; said cover having at least one aperture that is optionally larger than the dental item; a pierceable layer positioned to cover said aperture and a deformable layer at least partially enclosing said the aperture, such that the dental item is held between the deformable layer and the pierceable layer.

2. A method of storing and dispensing a dental item, comprising providing a closeable cover and means to maintain the cover in its closed manner; said cover having at least one aperture that is optionally larger than the dental item; a pierceable layer positioned to cover said aperture and a deformable layer at least partially enclosing said the aperture, such that the dental item is held between the deformable layer and the pierceable layer; and removing the dental item by deforming the deformable layer such that pressure is exerted upon the dental item of sufficient force that the item causes the pierceable layer to be pierced sufficiently such that the item can be removed.
